(19) United States
(12) Patent Application Publication
(10) Pub. No.: US 2009/0185467 A1
(43) Pub. Date: Jul. 23, 2009

(54) METHOD AND DEVICE FOR STORING DATA ON A RECORD MEDIUM AND FOR TRANSFERRING INFORMATION

(75) Inventor: Robert Albertus Brondijk, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/575,572

(22) PCT Filed: Sep. 20, 2005
(86) PCT No.: PCT/IB05/53084

§ 371 Date: Mar. 20, 2007

(30) Foreign Application Priority Data
Sep. 28, 2004 (EP) 04104719.2

(51) Int. Cl. G11B 19/04

(52) U.S. Cl. 369/53.21; G9B/19.005

(57) ABSTRACT

Data storage system (1) comprises: an optical disc (2) having a storage space (3) for receiving sectors of data; a disc drive (10), suitable for writing information to the disc; a host (20), capable of cooperating with the drive; the host being designed to send to said drive a write encrypted sector command WESC(EKI) for commanding said drive to write one or more bus-encrypted sectors to said disc, WESC(EKI) including an encryption key identifier EKI; the drive being designed, in response to receiving said WESC(EKI), to evaluate the value of EKI, and, if the value of EKI indicates a bus-encrypted user data portion (32E), to decrypt this user data portion, to generate a header portion (31) with bus encryption information BEI, to combine this header portion with the decrypted user sector portion (32) to make a data sector (30), and to write the data sector (30) to the disc.

### FIELD OF THE INVENTION

The present invention relates in general to the field of storing data on a record medium. The present invention relates particularly to the field of optical storage, such as CD, DVD, BluRay, and the invention will be explained hereinafter for the case of BluRay, but it is to be noted that this is by way of example only and is not intended to restrict the scope of the invention. The gist of the present invention is also applicable to other types of recordable discs, either optical or not, and the gist of the present invention is even applicable to recordable media other than disc type.

### BACKGROUND OF THE INVENTION

Since the technology of optical data storage in general, including the way in which information can be stored in an optical disc, is commonly known, it is not necessary here to explain this technology in great detail. It is briefly summarized that an optical storage disc comprises at least one track, either in the form of a continuous spiral or in the form of multiple concentric circles, of storage space where information may be stored in the form of a data pattern. The storage space is divided into blocks. The data to be written is organized into data sectors, each sector comprising a user data portion and a header portion. A data sector is written into a storage block. The user data portion contains the actual data of interest (payload), while the header portion contains additional information relating, amongst others, to the organization of the data storage.

For writing information into the storage space of the optical storage disc, or for reading information from the storage space of the optical storage disc, the storage track is scanned by an optical beam, typically a laser beam. The actual handling of the storage disc is performed by an apparatus that will be indicated as disc drive apparatus. This handling includes the functions of receiving, holding, and rotating the disc. This handling also includes the functions of generating the laser beam(s); directing, focussing and displacing the laser beam(s); suitably modulating the laser beam(s) for writing; sensing the reflected beam(s) for reading. This handling also includes the functions of error correction, deciding which information to write at which physical addresses, etc.

The above-mentioned general functions of the disc drive apparatus are known per se. The present invention is not aiming at improving these general functions; in fact, the present invention may be implemented while using the general functions according to the state of the art. Therefore, a more detailed description and explanation of these general functions is omitted here. It suffices to say that the disc drive apparatus has a data input for receiving data-to-be-stored, and a data output for outputting data-read-from-disc.

Typically, apart from an optical disc as a record medium and a disc drive apparatus for handling the disc, an optical storage system comprises a host apparatus. The host apparatus, which may be a PC running a suitable program, or an application of a consumer apparatus such as a video recorder, is a device which communicates with the disc drive, sending data and commands to the disc drive instructing the disc drive to write the data to a certain storage location, or sending commands to the disc drive instructing the disc drive to read data from a certain storage location, and receiving data from the disc drive. For the purpose of explaining the present invention, it is immaterial what the host intends to do with the data. It suffices to say that the host apparatus has a data input for receiving data-read-from-disc, and a data output for outputting data-to-be-stored. It is to be noted that, when sending data to the disc drive, the host already sends the data in the form of sectors.

The data communication from host to disc drive and vice versa takes place over a communication channel of a data bus, which bus may be shared with other users. In view of the need of protection against piracy, the host typically encrypts the data before sending it to the disc drive, using a so-called bus key, which is only known to the host and the disc drive. This bus key is only intended to protect the communication between host and disc drive, and should be removed (decryption of data) before the data is written to the disc. The data sent by the host to the disc drive comprises a mix of actual data or payload which needs to be protected, for instance audio information, video information, etc, and control data such as title, creation day, file system information, etc. A problem with encryption is that all data looks alike, i.e. the disc drive is not capable to distinguish between “true data” and “auxiliary data”.

Thus, not all data is encrypted by the host. Typically, the distinction is on the level of sectors: a sector is either encrypted or non-encrypted. Consequently, not all sectors should be decrypted by the disc drive. Since there is no way to recognize encrypted sectors from non-encrypted sectors, the host should tell the disc drive which sector is bus-encrypted and which sector is not. In the following, such sector will be indicated as bus-encryption sector.

A problem to be solved here is how the host should tell the disc drive which sector is a bus-encryption sector and which sector is not.

A further problem exists in the case of reading. Again, some but not all of the sectors should be bus-encrypted by the disc drive for communication over the bus to the host. Now the problem is more complicated, because there should be found a way of communicating to the disc drive which sector it should bus-encrypt and which sector it should not bus-encrypt.

In US Patent Application 2003/0.091.187, Fontijn et al disclose a related but different technique, and its associated problems, namely the technique of the disc drive encrypting data before writing the data to the disc, using an encryption key which is also stored on the disc, albeit in a hidden location. This key will hereinafter be indicated as disc key. Typically, all sectors of one file are disc-encrypted with the same disc key. In such case, the host, when issuing a read command to the disc drive, should also indicate which disc key is to be used for decryption. Then, the disc drive uses this disc key for all sectors of the file. Thus, this publication does not give any suggestion how to solve the problem mentioned above.

Accordingly, an important objective of the present invention is to overcome the above problems.

### SUMMARY OF THE INVENTION

According to an important aspect of the present invention, encryption information relating to the issue whether or not a sector is a bus-encryption sector is included in the header portion of such sector. This enables a disc drive, when reading such sector from disc, to determine whether or not it should bus-encrypt the contents of the sector before communicating the sector to a host.

However, the header portion of a sector is not user-accessible, i.e. a host has no direct control over the contents of a header portion. Thus, it is not possible for the host to actually give a header write command to the disc.

According to a further important aspect of the present invention, a data write command contains at least one encryption command bit indicating whether or not the sector in question is a bus-encryption sector. Further, a disc drive apparatus is adapted, in response to receiving such encryption command bit in a write command, to include the encryption information in the header portion of a sector, relating to the issue whether or not the sector is a bus-encryption sector. Further, a disc drive apparatus is adapted, when reading a sector from disc, to assess the encryption information in the header portion of this sector, to determine whether the encryption information is indicative of a bus-encryption sector, and in response to implement bus-encryption or not.

In a further elaboration of the present invention, the encryption information in the header portion may even contain a key coding indicating which bus-encryption key is to be used. A data read command may contain a key parameter. The disc drive apparatus may be adapted, when receiving a read command, to read a sector, to assess the encryption information in the header portion of this sector, to compare the key coding in the encryption information with the key parameter in the data read command, and to only communicate the sector to the host if the key parameter in the data read command corresponds to the key coding in the encryption information.

### BRIEF DESCRIPTION OF THE DRAWINGS

These and other aspects, features and advantages of the present invention will, be further explained by the following description with reference to the drawings, in which same reference numerals indicate same or similar parts, and in which:

FIG. 1 is a block diagram schematically illustrating a data storage system;

FIG. 2 is a diagram schematically depicting the block structure of the storage space of a storage medium;

FIG. 3 is a diagram schematically illustrating a data sector;

FIG. 4 is a block diagram comparable to FIG. 1, schematically illustrating a process of writing a bus-encrypted sector;

FIG. 5 is a table illustrating a command descriptor block of a write command suitable for use in a write method in accordance with the present invention;

FIG. 6 is a block diagram comparable to FIG. 4, schematically illustrating a process of reading a sector which is to be bus-encrypted;

FIG. 7 is a table illustrating a command descriptor block of a read command suitable for use in a read method in accordance with the present invention.

### DESCRIPTION OF THE INVENTION

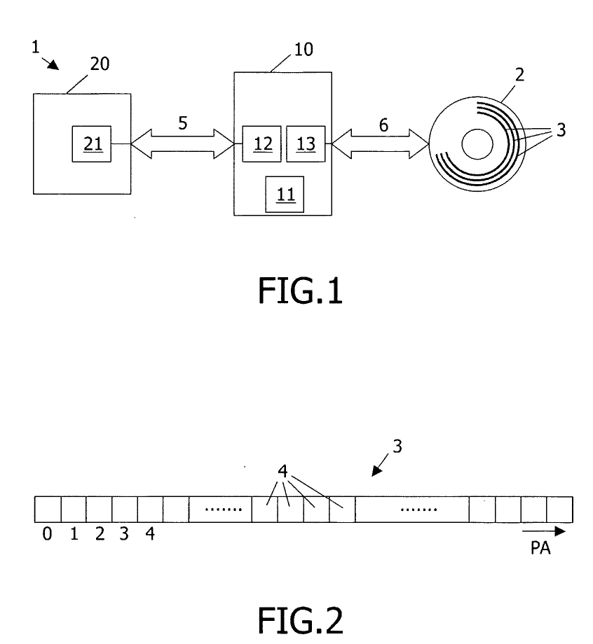

FIG. 1 is a block diagram schematically illustrating a data storage system 1, comprising a data storage medium 2, a medium access device 10, and a host device 20. In a typical practical implementation, the host device 20 may be a suitably programmed personal computer (PC); it is also possible that the data storage system 1 is implemented as a dedicated user apparatus such as a video recorder, in which case the host device 20 is the application part of such apparatus. In a specific embodiment, the data storage medium 2 is implemented as an optical disc, for instance a DVD or a BD, in which case the medium access device 10 is implemented as a disc drive. In the following, the invention will be described specifically for an optical disc implementation, but it is noted that the present invention is not limited to optical discs.

The optical disc 2 has a storage space 3, which has the form of one or more continuous spiral-shaped tracks or one or more tracks in the form of multiple concentric circles, where information can be stored in the form of a data pattern. Since this technology is commonly known to persons skilled in the art, this technology will not be explained in further detail.

FIG. 2 is a diagram schematically illustrating that the storage space 3 is divided into a large number of blocks 4. Each block has a specific physical address PA.

When the host device 20 wants to access a certain piece of information, it sends a request to the disc drive 10, indicating the corresponding logical address LA. The disc drive 10 comprises a memory 11, which contains information regarding the relationship between logical addresses LA and physical addresses PA, for instance in the form of a look-up table. Based on this information, the disc drive 10 determines which physical address corresponds to the required logical address.

In FIG. 1, a host/drive communication link between host device 20 and disc drive 10 is indicated at 5. Likewise, a drive/disc communication link between disc drive 10 and disc 2 is indicated at 6. The drive/disc communication link 6 represents the physical (optical) read/write operation as well as the physical addressing of blocks 4 of the storage space 3. The host/drive communication link 5 represents a data transfer path as well as a command transfer path.

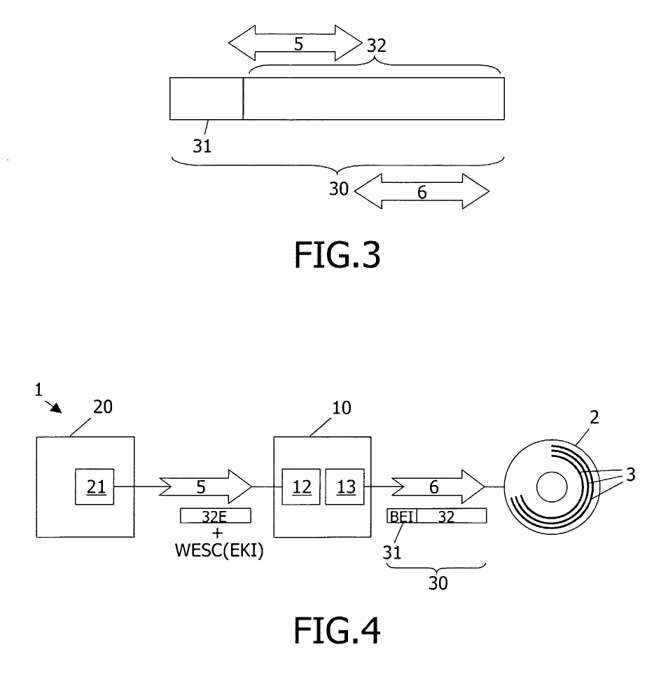

FIG. 3 is a diagram illustrating that a data sector 30 as contained in a block 4 of the storage space 3 comprises a header portion 31 and a user data portion 32. Only the user data portion 32 is communicated between host device 20 and disc drive 10, whereas the combination of header portion 31 and user data portion 32 is communicated between disc drive 10 and disc 2.

The host device 20 may decide to send a user data sector portion 32 as a bus-encrypted sector. The host device 20 may also receive from the disc drive 10 encrypted data, which needs to be decrypted. Therefore, the host device 20 comprises a bus-encryption/decryption unit 21: Likewise, the disc drive 10 comprises a bus-encryption/decryption unit 12.

When the host device 20 decides to send a “normal” user sector portion 32 to be written to the disc drive 10, it sends the user sector 32 accompanied by a write sector command WSC. Write sector commands are known in the prior art. In response to receiving the write sector command WSC, the disc drive 10 is adapted to generate a header portion 31, to combine this with the user sector portion 32 to make the data sector 30, and to write the data sector 30 to disc 2; this procedure is also known in the prior art.

When the host device 20 decides to send a bus-encrypted user sector portion 32 to be written to the disc drive 10, it sends the encrypted user sector portion 32E accompanied by a write encrypted sector command WESC. In response to receiving the write encrypted sector command WESC, the disc drive 10 is adapted to decrypt the encrypted user sector portion 32E, to generate a header portion 31 with bus encryption information BEI, to combine this header portion 31 with the decrypted user sector portion 32 to make the data sector 30, and to write the data sector 30 to disc 2. This procedure is schematically illustrated in FIG. 4.

The bus encryption information BEI indicates, on the one hand, that the corresponding user sector portion 32 of the data sector 30 has been communicated to the disc drive using bus-encryption, and also indicates, on the other hand, that, in the case of a reading procedure, the disc drive should communicate to the host the corresponding user sector portion 32 of the data sector 30 using bus-encryption. In a possible embodiment, the bus encryption information BEI may even indicate which bus-encryption key the disc drive is to use when communicating to the host.

There are several practical possibilities envisaged for implementing the write encrypted sector command WESC. First, it is of course possible to define an entirely new command. However, it is easier to adapt existing commands of an existing command set. An example of a widely used command set is indicated as MMC3, also indicated as “Mount Fuji” (see, for instance, www.t10.org: “Multimedia Command Set Version 3 Revision 10G”). In the following, an example of a suitable existing command will be described.

### EXAMPLE 1

### WRITE (12) Command (W12)

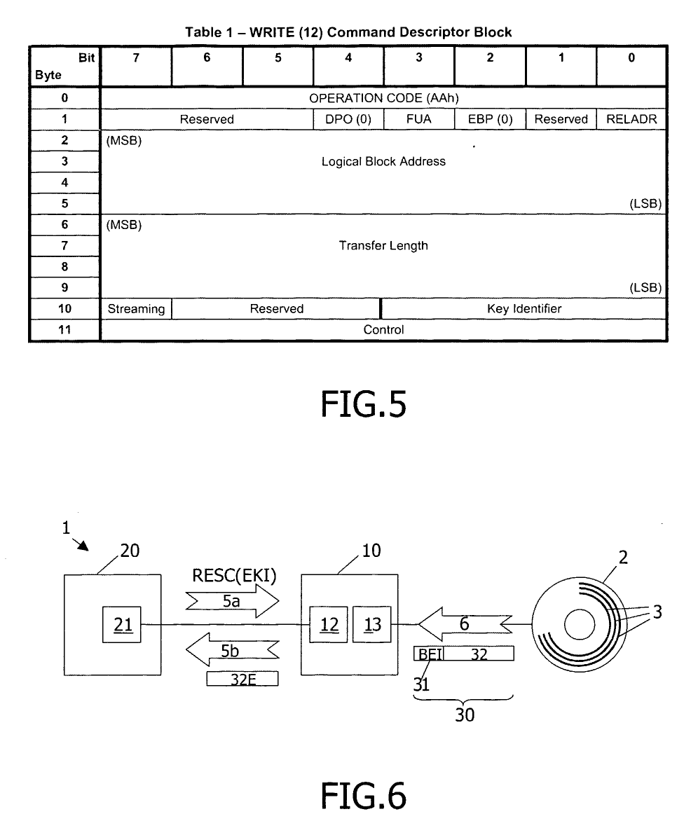

FIG. 5 is a table illustrating a W12 command descriptor block, adapted in accordance with the present invention.

As illustrated by the table in FIG. 5, the W12 command comprises 12 bytes of 8 bits each. Byte 0 contains an operation code, bytes 2-5 are used to indicate the logical block address of the storage space where the data sector 30 should be stored, and bytes 6-9 are used to indicate the length of the data sector 30 to be transferred. Byte 11 is a control byte.

Bits 5-7 of byte 1, and bytes 0-6 of byte 10 are reserved for later definition, i.e. they do not have a defined meaning yet. So, it is possible to use any one of these bits as an encryption bit EB, indicating that the W12 command is to be taken as a write encrypted sector command WESC.

In the embodiment as illustrated in FIG. 5, the first four bits 0-3 of byte 10 are used as an encryption key identifier EKI. The value EKI=0 means “no encryption”, which is compatible with current hosts 20 and current disc drives 10. The value EKI≠0 may indicate that the W12 command is to be taken as a write encrypted sector command WESC. Thus, the encryption key identifier EKI can take 15 different values, each indicating a write encrypted sector command WESC, wherein the 15 different values of the encryption key identifier EKI may indicate different encryption keys to use.

It is noted that, before issuing a WESC command, the host communicates with the drive to decide on a certain EKI to use, but this is not shown in the figures.

It is possible that specific values of the encryption key identifier EKI are used to indicate specific encryption commands. For instance, one specific value of EKI may indicate the command “mark as encrypted but do not bus encrypt”.

FIG. 6 is a block diagram comparable to FIG. 4, schematically illustrating a process of reading a sector which is to be bus-encrypted.

First, the host device 20 issues a read encrypted sector command RESC, including an encryption key identifier EKI, as indicated by communication arrow 5a. In response, the disc drive 10 reads a sector 30 from the address indicated in the read encrypted sector command RESC, as indicated by communication arrow 6. In its header 31, this sector contains bus encryption information BEI.

If the bus encryption information BEI of a sector indicates “no encryption”, the disc drive 10 will send the user portion 32E to the host 20 without encrypting it.

If the bus encryption information BEI of a sector indicates “encryption”, the disc drive 10 will encrypt the user portion 32 of the sector 30, using the encryption key as indicated by the encryption key identifier EKI in the read encrypted sector command RESC, and the disc drive 10 will send the encrypted user portion 32E to the host 20, as indicated by communication arrow 5b.

In a possible embodiment, the disc drive 10 is designed to compare the encryption key identifier EKI as contained in the read encrypted sector command RESC with the bus encryption information BEI as contained in the header 31. If there is a match, the disc drive 10 will encrypt the user portion 32 of the sector 30, using the encryption key as indicated by the encryption key identifier EKI in the read encrypted sector command RESC, and will send the encrypted user portion 32E to the host 20, as indicated by communication arrow 5b. If there is no match, the disc drive 10 will return an error message to the host 20.

It is noted that it is not necessary for the disc drive 10 to send encryption key information to the host 20, since the host knows which key to use, as follows from the fact that the host has sent the encryption key identifier EKI to the disc drive.

There are several practical possibilities envisaged for implementing the read encrypted sector command RESC. First, it is of course possible to define an entirely new command. However, it is easier to adapt existing commands of an existing command set: In the following, an example will be described of a suitable existing command from the above-mentioned command set MMC3.

### EXAMPLE 2

### READ (12) Command (R12)

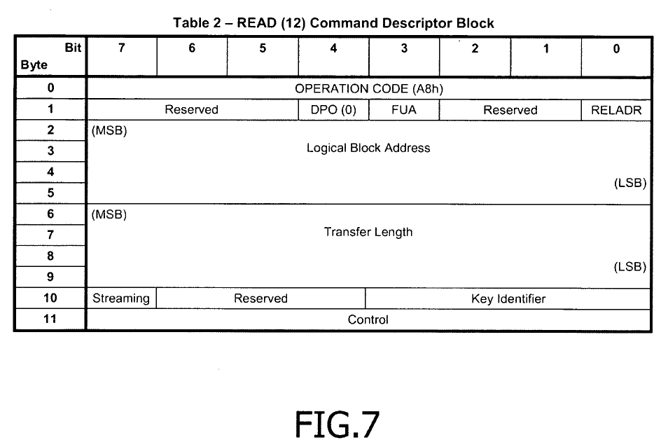

FIG. 7 is a table illustrating a R12 command descriptor block, adapted in accordance with the present invention.

As illustrated by the table in FIG. 7, the R12 command comprises 12 bytes of 8 bits each. Byte 0 contains an operation code, bytes 2-5 are used to indicate the logical block address of the storage space where the data sector 30 should be read, and bytes 6-9 are used to indicate the length of the data sector 30 to be transferred. Byte 11 is a control byte.

Bits 5-7 of byte 1, and bytes 0-6 of byte 10 are reserved for later definition, i.e. they do not have a defined meaning yet. So, it is possible to use any one of these bits as an encryption bit, indicating that the R12 command is to be taken as a read encrypted sector command RESC.

In the embodiment as illustrated in FIG. 7, the first four bits 0-3 of byte 10 are used as an encryption key identifier EKI. The value EKI=0 means “no encryption”, which is compatible with current hosts 20 and current disc drives 10. The value EKI≠0 may indicate that the R12 command is to be taken as a read encrypted sector command RESC. Thus, the encryption key identifier EKI can take 15 different values, each indicating a read encrypted sector command RESC, wherein the 15 different values of the encryption key identifier EKI may indicate different encryption keys to use to be used by the disc drive 10 for bus-encrypting the sectors communicated to the host 20.

Thus, it should be clear that the present invention succeeds in providing a data storage system comprising:
an optical disc 2 having a storage space 3 for receiving sectors of data, each sector 30 comprising a header portion 31 and a user data portion 32;
a disc drive 10, suitable for writing information to and reading information from the disc;
a host 20, capable of cooperating with the drive;
   the host being designed to send to said drive a write encrypted sector command WESC(EKI) for commanding said drive to write one or more bus-encrypted sectors to said disc, the write encrypted sector command WESC(EKI) including an encryption key identifier EKI;
the drive being designed, in response to receiving said write encrypted sector command WESC(EKI), to evaluate the value of the encryption key identifier EKI, and, if the value of the encryption key identifier EKI indicates a bus-encrypted user data portion 32E, to decrypt this user data portion 32E, to generate a header portion 31 with bus encryption information BEI, to combine this header portion 31 with the decrypted user sector portion 32 to make the data sector 30, and to write the data sector 30 to the disc.

It should be clear to a person skilled in the art that the present invention is not limited to the exemplary embodiments discussed above, but that several variations and modifications are possible within the protective scope of the invention as defined in the appending claims.

For instance, the encryption key identifier EKI may contain only one bit, merely indicating whether or not the corresponding sector is to be encrypted without indicating any key.

In the above, the present invention has been explained with reference to block diagrams, which illustrate functional blocks of the device according to the present invention. It is to be understood that one or more of these functional blocks may be implemented in hardware, where the function of such functional block is performed by individual hardware components, but it is also possible that one or more of these functional blocks are implemented in software, so that the function of such functional block is performed by one or more program lines of a computer program or a programmable device such as a microprocessor, microcontroller, digital signal processor, etc.

1. Host device (20), capable of cooperating with a medium access device (10) suitable for writing information to a storage medium (2) which has a storage space (3) for receiving sectors of data, each sector (30) comprising a header portion (31) and a user data portion (32);
the host device (20) being designed to send (5) to said medium access device (10) one or more bus-encrypted sector user data portions (32E) to be written;
the host device (20) being designed to send (5) to said medium access device (10) a write encrypted sector command WESC(EKI) for commanding said medium access device (10) to write the one or more bus-encrypted sectors to said storage medium (2), the write encrypted sector command WESC(EKI) including an encryption key identifier EKI.

2. Host device according to claim 1, wherein the encryption key identifier EKI contains only one bit.

3. Host device according to claim 1, designed to send said write encrypted sector command WESC(EKI) as a WRITE-12-COMMAND

4. Host device according to claim 3, wherein the first four bits 0-3 of byte 10 of the write encrypted sector command WESC(EKI) are used as encryption key identifier EKI.

5. Medium access device (10), suitable for writing information to a storage medium (2) which has a storage space (3) for receiving sectors of data, each sector (30) comprising a header portion (31) and a user data portion (32);
the medium access device (10) being designed to receive (5) from a host device (20) a write encrypted sector command WESC(EKI) including an encryption key identifier EKI;
the medium access device (10) being designed, in response to receiving said write encrypted sector command WESC(EKI), to evaluate the value of the encryption key identifier EKI, and, if the value of the encryption key identifier EKI indicates a bus-encrypted user data portion (32E), to decrypt this user data portion (32E), to generate a header portion (31) with bus encryption information BEI, to combine this header portion (31) with the decrypted user sector portion (32) to make the data sector (30), and to write the data sector (30) to the storage medium (2).

6. Medium access device according to claim 5, wherein the bus encryption information BEI contains the encryption key identifier EKI.

7. Medium access device according to claim 5, wherein the bus encryption information BEI contains only one bit.

8. Host device (20), capable of cooperating with a medium access device (10) suitable for reading information from a storage medium (2) which has a storage space (3) for receiving sectors of data, each sector (30) comprising a header portion (31) and a user data portion (32), at least one header portion (31) comprising bus encryption information BEI;
the host device (20) being designed to send (5) to said medium access device (10) a read encrypted sector command RESC(EKI) for commanding said medium access device (10) to read one or more sectors from said storage medium (2), the read encrypted sector command RESC(EKI) including an encryption key identifier EKI relating to a bus-encryption key.

9. Medium access device (10), suitable for reading information from a storage medium (2) which has a storage space (3) for receiving sectors of data, each sector (30) comprising a header portion (31) and a user data portion (32), at least one header portion (31) comprising bus encryption information BEI;
the medium access device (10) being designed to receive (5) from a host device (20) a read encrypted sector command RESC(EKI) including an encryption key identifier EKI relating to a bus-encryption key;
the medium access device (10) being designed, in response to receiving said read encrypted sector command RESC(EKI), to evaluate the value of the encryption key identifier EKI, and, if the value of the encryption key identifier EKI indicates bus-encryption:
to read from the storage medium (2) a data sector (30) as indicated by the read encrypted sector command RESC(EKI);
to derive bus encryption information BEI from the header portion (31) of the data sector (30);
to evaluate the value of the bus encryption information BEI, and, if the value of the bus encryption information BEI indicates “bus-encryption”, to encrypt the user portion (32) of the sector (30), using an encryption key as indicated by the encryption key identifier EKI in the read encrypted sector command RESC, and to send the thus encrypted user portion (32E) to the host device (20).

10. Medium access device according to claim 9, the medium access device being designed, if the value of the bus encryption information BEI indicates “no bus-encryption”, to send to the host device (20) the user portion (32E) without bus-encryption.

11. Medium access device according to claim 9, the medium access device being designed to compare the encryption key identifier EKI as contained in the read encrypted sector command RESC with the bus encryption information BEI derived from the header portion (31) of the data sector (30), and, if there is no match, to issue an error message.

12. Medium access device according to claim 9, designed, if the value of the encryption key identifier EKI indicates “no bus-encryption”, to read from the storage medium (2) a data sector (30) as indicated by the read encrypted sector command RESC(EKI), and to send to the host device (20) the user portion (32) of the sector (30) without bus-encryption.

13. Data storage system (1), comprising:
a storage medium (2) having a storage space (3) for receiving sectors of data, each sector (30) comprising a header portion (31) and a user data portion (32), at least one header portion (31) comprising bus encryption information BEI;
a medium access device (10) in accordance with claim 5.

14. Data storage system (1), comprising:
a storage medium (2) having a storage space (3) for receiving sectors of data, each sector (30) comprising a header portion (31) and a user data portion (32), at least one header portion (31) comprising bus encryption information BEI;
a medium access device (10) in accordance with claim 9.

15. Data storage system according to claim 13, wherein said storage medium is an optical disc, preferably a CD, a DVD, or a BD, and wherein said medium access device is a disc drive.
